(19) United States
(12) Patent Application Publication
(10) Pub. No.: US 2012/0006231 A1
(43) Pub. Date: Jan. 12, 2012

(54) SYNTHETIC AGGREGATE WITH PHOTOCATALYTIC PROPERTIES FOR ROAD USE AND PRODUCTION METHOD THEREOF

(75) Inventors: Xavier Bricout, Voisins Le Bretonneux (FR); Jean Eric Poirier, Montigny Le Bretonneux (FR)

(73) Assignee: COLAS, Boulogne-Billancourt (FR)

(21) Appl. No.: 13/257,671

(22) PCT Filed: Mar. 25, 2010
(86) PCT No.: PCT/FR2010/050546

§ 371 Date: Sep. 20, 2011

(30) Foreign Application Priority Data
Mar. 25, 2009 (FR) 0951938

(51) Int. Cl. C04B 14/30; B05D 3/00; B05D 5/00; C04B 14/06; B05D 7/00

(52) U.S. Cl. 106/446; 106/482; 427/215

(57) ABSTRACT

A synthetic aggregate with photocatalytic properties for road use, includes a collection of particles each including a matrix formed by a binder containing at least photocatalytic particles and a particulate mineral material. The method of producing the synthetic aggregate and its use in a pollution-reducing road surface course having excellent tyre grip are also described.

The present invention relates to a synthetic aggregate with photocatalytic properties for road use, and also to the process for producing it and to a wearing course incorporating it.

In order to have both a long service life and maximum safety for users, the wearing course of a road must have particular mechanical and physicochemical properties, for instance resistance to traffic and capacity for adherence of tires under wet or dry conditions.

The adherence of tires on a wearing course depends mainly on the surface state of the road. Thus, on a wet roadway, this surface state must enable rupture of the film of water that forms between the road and the tires.

The micro-roughness of the aggregate at the surface of the wearing course of the road determines to a large part the surface state of the road. The higher the micro-roughness of the aggregate, the better will be the adherence of the tires to the wearing course. In order to maintain high micro-roughness of the aggregate throughout its service life, it must consequently have certain surface characteristics, and, especially, good resistance to abrasion and to polishing.

Thus, document FR 2 858 614 discloses a process for producing synthetic aggregates from crushed concrete formulations, the micro-roughness of which is greater than that which may be found in natural rocks, and which have high abrasion resistance. Such granualates are intended for sections of road that require maximum adherence of the tires to the wearing course.

However, over time, fouling of the surface of the road and of the aggregate takes place from the soiling derived both from the immediate environment of the road and from the vehicle traffic and the pollution arising therefrom. This results in a gradual decrease in the apparent micro-roughness of this aggregate, and thus consequently a gradual loss of adherence of tires to the wearing course.

One aim of the invention is to propose a synthetic aggregate that has excellent micro-roughness that is conserved over time, so as to ensure permanent adherence properties.

This aim is achieved by the production of a synthetic aggregate with photocatalytic properties. Specifically, its photocatalytic properties give the aggregate a superhydrophilic surface that is self-cleaning with regard to any organic pollution, and thus allow maintenance of its excellent micro-roughness over time.

Specifically, the presence of photocatalyst particles at the surface of the aggregate, combined with UV and visible solar radiation, allows the decomposition of organic molecules at the surface of the photocatalyst particles. These self-cleaning properties increase with the micro-roughness of the aggregate.

The term “superhydrophilic surface” means a surface that has total affinity for water, which has the effect of loosening soiling that becomes deposited at the surface, whether it is mineral or organic soiling.

However, a wearing course is particularly exposed to pollution: combustion residues, traces of tires or other soiling become deposited on its surface and contribute toward its fouling. It has been observed that photocatalyst particles can totally or partially decompose this soiling, and facilitate its removal.

Despite its high abrasion resistance, the synthetic aggregate with catalytic properties will undergo, like any aggregate, inevitable polishing of its surface over time, especially due to the action of traffic. The presence of photocatalyst particles in the matrix of the aggregate enables it to conserve its self-cleaning and superhydrophilic properties over time, by renewing the surface gradually as wear takes place. As the surface unevenness is not filled in by the soiling, the micro-roughness of the aggregate is maintained, and the adherence properties of tires to the wearing course also persist.

The synthetic aggregate of the invention is formed from an assembly of grains, each comprising, included in a matrix formed by a binder, at least photocatalyst particles and a particulate mineral material.

The invention thus relates to a synthetic aggregate with photocatalytic properties for road use, formed from an assembly of grains, each comprising, included in a matrix formed by a hydraulic or pozzolanic binder, at least photocatalyst particles and a particulate mineral material that is a sand, the synthetic aggregate having a particle size d/D with D between 4 and 10.

In a first embodiment of the invention, the matrix formed by a first binder, which comprises the particulate mineral material and the photocatalyst particles, constitues the core of the grains of the synthetic aggregate.

In a second embodiment of the invention, the matrix formed by a second binder, which comprises the particulate mineral material and the photocatalyst particles, is at the surface of the grains of the synthetic aggregate, where it constitutes a coating layer, the core of the grains of the synthetic aggregate then being formed by the grains of a starting aggregate.

The photocatalyst is advantageously a semiconductor compound, preferably titanium dioxide. Among the various allotropic forms of titanium dioxide, the preferred forms are rutile, anatase, brookite and more particularly the anatase form.

It is thus possible to use the photocatalysts known under the following names: Hombikat® UV100 (Sachtleben), Kronos® VLP7000 (Kronos), Kronos® VLP7500 (Kronos), Kronos® VLP7101 (Kronos) and Aeroxide® P25 (Evonik). Preferably, the photocatalyst Hombikat® UV100 (Sachtleben) will be used.

In the first embodiment of the invention, when the photocatalyst is titanium dioxide, the synthetic aggregate preferably comprises between 0.5% and 50% by weight of photocatalyst particles relative to the total weight of the grains, and advantageously between 5% and 15% by weight relative to the total weight of the grains.

In the second embodiment of the invention, when the photocatalyst is titanium dioxide, the synthetic aggregate preferably comprises between 0.02% and 40% by weight of photocatalyst particles relative to the total weight of the grains, and advantageously between 0.2% and 12% by weight relative to the total weight of the grains.

Advantageously, the particulate mineral material has a hardness higher than that of the matrix in which it is included and forms hard inclusions in the grains of the aggregate. These inclusions form unevenness at the surface of the grains of the aggregate, and are responsible for the micro-roughness of the aggregate.

In order to enable optimum adherence of tires to the wearing course, it is desirable for the relief of the grains to hug the surface of the tires, thus creating a large contact area. Advantageously, the particulate mineral material comprises particles less than 1.5 mm in size, preferably between 1 and 1.2 mm, thus forming indentations of about 200 μm at the surface of the grains.

To ensure the durability of the unevenness formed by the particles of the particulate mineral material, it is preferable for this material to be of good mechanical quality. Consequently, the particulate mineral material is preferentially derived from a parent rock that has good mechanical properties, and in particular good wear resistance and fragmentation resistance. Any rock of natural origin that has Los Angeles coefficient values of less than 12 and Micro-Deval coefficient values of less than 20 is preferentially used.

The particulate mineral material is preferably a sand, in particular a gneiss sand or a dioritic sand. The particulate mineral material may also be a mixture of several particulate mineral materials.

The starting aggregate used in the second embodiment of the invention may be any natural or synthetic aggregate, in accordance with use in a wearing course according to standard NF EN 13043.

The first binder forming the matrix of the core of the grains of the synthetic aggregate is a hydraulic or pozzolanic binder within the meaning of standard NF P15-108.

The second binder forming the matrix of the layer coating the surface of the grains of the synthetic aggregate is also a hydraulic or pozzolanic binder within the meaning of standard NF P15-108. It may be identical to or different than the first binder forming the matrix of the core of the grains of the synthetic aggregate.

In order to obtain good development of their mechanical performance, reflected especially by good adherence of the inclusions in the matrix, these first and second binders preferably comprise a cement and a silica fume.

In order for the synthetic aggregate not to be intrinsically sensitive to photodegradation, besides the particulate mineral material, all the additional constituents that form the grains are preferably of mineral nature.

The production of the synthetic aggregate according to the first embodiment of the invention is performed via the following steps:
(a) preparation of a mortar comprising a particulate mineral material, a first binder and photocatalyst particles;
(b) curing of said mortar;
(c) crushing of said mortar into grains; and
(d) curing of said mortar grains;
   via which said synthetic aggregate is obtained.

Step (a) of the process may be performed according to two methods.

According to the first method, in step a), said photocatalyst particles are mixed simultaneously with, on the one hand, said first binder and with, on the other hand, said particulate mineral material. According to this first method:
first, a particulate mineral material is provided,
second, components intended to form a first binder are provided,
third, photocatalyst particles are also provided, and then
a predetermined amount of said particulate mineral material is simultaneously mixed with a predetermined amount of said photocatalyst particles and with a predetermined amount of each of said components intended to form a first binder,
wherein a mortar is obtained comprising, in a matrix formed by a first binder, both photocatalyst particles and inclusions corresponding to the particulate mineral material.

According to the second method, in step a), said photocatalyst particles are mixed with said first binder before mixing with said particulate mineral material. According to this method:
first, a particulate mineral material is provided,
second, components intended to form a first binder are provided, which components comprise photocatalyst particles, and then
a predetermined amount of said particulate mineral material is mixed with a predetermined amount of each of said components intended to form a first binder,
wherein a mortar is obtained comprising, in a matrix formed by a first binder, both photocatalyst particles and inclusions corresponding to the particulate mineral material.

Preferably, the main components intended to form the first binder of the mortar are chosen from cements, silica fume, superplasticizers and water. In practice, the matrix formed by the first binder comprises a cement, thus making it possible to obtain a mortar whose compression strength is high. The superplasticizer itself makes it possible to limit the water/cement ratio.

As has been mentioned above, the photocatalyst particles are either incorporated into the components intended to form a first binder, or mixed simultaneously with the other constituents of the mortar. In these two cases, the amount of photocatalyst is determined such that the photocatalyst particles represent between 0.5% and 50% by weight and advantageously between 5% and 15% by weight relative to the total weight of the synthetic aggregate obtained.

Step (b) of the process is a curing step, which corresponds to a treatment of the mortar to control the exchanges of water and/or heat with the external medium. In practice, curing makes it possible to prevent dehydration of the matrix and promotes hydration that tends to consolidate it. In consequence, the conditions (time and temperature) under which curing is performed determine the consolidation of the matrix and thus of the mortar. In order to make substantial roughness appear within the mortar, it is essential for the mortar to be hydrated, but for the curing allowing this hydration not to be too long. Specifically, crushing after a short period of curing makes it possible to lay bare a certain number of inclusions and thus to obtain substantial roughness.

In practice, the mortar is advantageously hydrated by curing that corresponds to a succession of two curing operations. The duration of the second curing is limited, such that the consolidation of the matrix is just sufficient for, firstly, the inclusions to adhere sufficiently in the matrix without becoming loose during the crushing, and, secondly, the ruptures brought about by the crushing to reveal a fractured appearance. It should be noted that in the case of a cement-based matrix, the sand inclusions combine with the cement to form lime silicates in the mortar. Thus, a second excessively long curing operation would lead to extremely strong adherence between the inclusions and the matrix, consequently promoting the appearance of intergranular ruptures within the inclusions themselves, which are synonymous with facies that are much smoother and thus less rough.

For the same purpose of multiplying the amount of unevenness, the particles of substantially micrometric size, known as fines, will advantageously have been removed by successive washing of the particulate mineral material before mixing with the first binder.

Step (c) of the process is a step of crushing the mortar, performed after the second curing. The crushing is performed several times, and the crushed mortar is then screened through a screen for selecting grains with a size of between 0 and 10 mm.

Step (d) of the process is a step of curing the mortar grains obtained after crushing. This third curing advantageously makes it possible to complete the hydration of the cement that started during the second curing, to finish the hardening of the matrix within the crushed mortar and thus to consolidate the grains obtained after crushing. This maturation leads to the development of an inclusions/matrix adherence that can ensure good consolidation of the particulate mineral material and of the first binder and thus limit the risk of loosening of the inclusions. After this third curing step (d), the mortar reaches maturity and consolidated grains are obtained.

The production of the synthetic aggregate according to the second embodiment of the invention is performed via the following steps:
(e) coating of a starting aggregate with a coating composition comprising a particulate mineral material, a second binder and photocatalyst particles;
(f) covering of the grains obtained with an antibonding agent or mobilizing of the grains for the first days; and
(g) curing of said coating composition;
   wherein said synthetic aggregate is obtained.

The starting aggregate used in step (e) of the process is preferentially characterized by a particle size d/D with d representing the smallest dimension in mm and D the largest dimension in mm, such that d is between 0 and 4 and D is between 4 and 10.

In one particular case of the second embodiment of the invention, the starting aggregate is identical to the synthetic aggregate produced according to the first embodiment of the invention, except that the mortar does not contain photocatalyst particles. This thus amounts to performing the following steps:

(a) preparation of a mortar comprising a particulate mineral material and a first binder;

(b) curing of said mortar;

(c) crushing of said mortar into grains;

(d) curing of said mortar grains;

wherein said starting aggregate used in step (e) of the process is obtained.

In this particular case, steps (b), (c) and (d) above are identical to steps (b), (c) and (d) of the process corresponding to the first embodiment of the invention, and step (a) above is performed in the following manner:
first, a particulate mineral material is provided,
second, components intended to form a first binder are provided, and then
a predetermined amount of said particulate mineral material is mixed with a predetermined amount of each of said components intended to form a first binder,
wherein a mortar is obtained comprising, in a matrix formed by a first binder, inclusions corresponding to the particulate mineral material.

The coating composition used in step (e) of the process may be obtained according to two methods.

According to the first method, said coating composition is obtained by simultaneous mixing of said photocatalyst particles with, on the one hand, said second binder and with, on the other hand, said particulate mineral material. According to this method:
first, a particulate mineral material is obtained,
second, components intended to form a second binder are provided,
third, photocatalyst particles are provided, and then
a predetermined amount of said particulate mineral material is simultaneously mixed with a predetermined amount of said photocatalyst particles and with a predetermined amount of each of said components intended to form a second binder,
wherein a coating composition is obtained comprising a particulate mineral material, a second binder and photocatalyst particles.

According to the second method, said coating composition is obtained by simultaneous mixing of said photocatalyst particles with said second binder before mixing with said particulate mineral material. According to this method:
first, a particulate mineral material is provided,
second, components intended to form a second binder are provided, which components comprise photocatalyst particles, and then
a predetermined amount of said particulate mineral material is mixed with a predetermined amount of each of said components intended to form a second binder,
wherein a coating composition is obtained comprising a particulate mineral material, a second binder and photocatalyst particles.

Preferably, the main components intended to form the second binder of the coating composition are chosen from cements, silica fume, superplasticizers and water. In a particularly preferred manner, the second binder is identical to the first binder.

As has been mentioned above, the photocatalyst particles are either incorporated into the components intended to form a second binder, or mixed simultaneously with the other constituents of the coating composition. In these two cases, the amount of photocatalyst is determined such that the photocatalyst particles represent either between 0.5% and 50% by weight and advantageously between 5% and 15% by weight, relative to the total weight of the coating composition, or between 0.02% and 40% by weight and advantageously between 0.2% and 12% by weight, relative to the total weight of the synthetic aggregate obtained.

Step (e) of the process is performed in the following manner:
first, a starting aggregate is provided,
second, a coating composition obtained according to one of the two methods described above is provided,
a predetermined amount of said starting aggregate is mixed in a mixer with a predetermined amount of said coating composition,
   wherein grains coated with said coating composition are obtained.

The amount of coating composition to be introduced into the mixer is calculated from the specific surface area of the starting aggregate. It is a matter of covering each grain of the starting aggregate with a coating layer preferably between 0.1 and 3 mm and advantageously between 0.5 and 1.5 mm thick.

Step (g) of the process is a curing step, identical to step (d) of the process corresponding to the first embodiment of the invention.

Prior to this curing step, a step (f) is performed during which the grains coated with the coating composition are covered with an antibonding agent. This step is necessary to prevent the aggregation of the grains during the following curing step (g). This antibonding agent may be chosen from mineral powders such as calcareous or siliceous fillers. It may also be liquid, and may correspond in this case, for example, to silicone oil or to liquid paraffin. Finally, it may be a concrete deactivator, which is capable of blocking the setting at the surface.

As a variant, in the case where no antibonding agent is available, it is possible to obtain a similar result by regularly mobilizing the grains during the first days that follow their preparation, so as to break the bonds that may have formed between them during this period.

After these steps (f) and (g), the synthetic aggregate is obtained, the grains of which are formed from a core coated with a consolidated coating layer. The synthetic aggregate is then screened in a screen for selecting the grain size.

Finally, the present patent application concerns the use of the synthetic aggregate with photocatalytic properties in a depolluting wearing course.

Finally, the present invention relates to a depolluting wearing course obtained by mixing a aggregate and a bituminous binder, in which at least part of the aggregate, and preferably all of it, is a synthetic aggregate as defined above.

A wearing course is obtained from a surfacing mix that comprises a mixture of a aggregate, a bituminous binder and optionally additives and/or fillers. According to the invention, at least some of the aggregates are synthetic aggregates with photocatalytic properties. The synthetic aggregate has a particle size d/D in which d is between 0 and 8 and preferably between 0 and 4 and D is between 4 and 10, preferably between 5 and 10 and better still between 6 and 10. The wearing course generally comprises 3% to 10% by weight of bituminous binder and 60% to 95% by weight of aggregate relative to the total weight of the wearing course.

Other characteristics and advantages will emerge more clearly from the examples that follow, which are given as nonlimiting illustrations.

### EXAMPLES

### I. First Embodiment of the Invention

The two compositions indicated in Table 1 below are given as examples of compositions for obtaining a synthetic aggregate with photocatalytic properties according to the first embodiment of the invention.

The compositions are expressed in kg of material per cubic meter of concrete.

TABLE 1
Compositions for obtaining a synthetic aggregate with photocatalytic
properties according to the first embodiment of the invention

| | | Example 1 | Example 2 |
|---|---|---|---|
| | | (in kg/m³) | (in kg/m³) |
| Particulate mineral material | Gneiss sand | 943 | — |
| for forming inclusions | Dioritic sand | — | 840 |
| Photocatalyst particles | Hombikat ® UV100 | 210 | 280 |
| Components for forming | Cement | 922 | 980 |
| the first binder | Silica fume | 72 | 0 |
| | Superplasticizer | 27 | 31 |
| Water | | 274 | 290 |
| Water/cement ratio | | 0.30 | 0.30 |

Considering Example 1, an amount substantially equal to 943 kg/m³ of gneiss sand is simultaneously mixed with an amount equal to 210 kg/m³ of photocatalyst particles and with a total amount substantially equal to 1021 kg/m³ of components intended to form the first binder and water.

Prior to mixing, the gneiss sand has preferentially undergone screening on a 1.5 mm screen so as to retain as particles only the sand grains preferentially less than or equal to 1.5 mm in size.

The mortar is obtained by mixing the abovementioned amounts, and by performing the first curing, and then the second curing. It is then crushed, and then screened to select grains preferentially between 6.3 and 10 mm in size. These grains are then subjected to the third curing.

Considering Example 2, an amount substantially equal to 840 kg/m³ of dioritic sand is simultaneously mixed with an amount equal to 280 kg/m³ of photocatalyst particles and with a total amount substantially equal to 1011 kg/m³ of components intended to form the first binder and water.

As for Example 1, prior to mixing, the dioritic sand has preferentially undergone screening, but rather on a 1 mm screen so as to retain as particles only the sand grains preferentially less than or equal to 1 mm in size. The same steps as those performed for the mortar of Example 1 are then carried out.

Such a synthetic aggregate with photocatalytic properties has extremely advantageous properties that enable it to be used in wearing courses that are both depolluting and showing excellent adherence to tires.

### II. Embodiment of the Invention

The two compositions indicated in Table 2 below are given as examples of compositions for obtaining a synthetic aggregate with photocatalytic properties according to the second embodiment of the invention.

TABLE 2
Compositions for obtaining a synthetic aggregate with photocatalytic
properties according to the second embodiment of the invention

| | | Example 3 | Example 4 |
|---|---|---|---|
| | | (in kg/m³) | (in kg/m³) |
| Particulate mineral material | Gneiss sand | 990 | — |
| for forming inclusions | Dioritic sand | — | 910 |
| Photocatalyst particles | Hombikat ® UV100 | 240 | 180 |
| Components for forming | Cement | 940 | 1000 |
| the second binder | Silica fume | 50 | 50 |
| | Superplasticizer | 25.2 | 29 |
| Water | | 275 | 300 |
| Water/cement ratio | | 0.29 | 0.3 |

Considering Example 3, a coating composition is prepared by mixing an amount equal to 990 kg/m³ of gneiss sand with an amount equal to 240 kg/m³ of photocatalyst particles and with a total amount substantially equal to 1015.2 kg/m³ of components for forming the second binder and water.

As for Example 1, prior to mixing, the gneiss sand has preferentially undergone screening on a 1.5 mm screen.

The synthetic aggregate A is obtained by mixing one tonne of 4/6 gravel of dioritic nature in a mixer with 1200 kg of the coating composition of Example 3, and then by covering the coated grains obtained with an antibonding agent such as shuttering-removal oils or the like and concrete inactivators, and by performing the final curing of the coating composition. One tonne of 5/7 gravel is then obtained.

Considering Example 4, a coating composition is prepared by mixing an amount equal to 910 kg/m³ of dioritic sand with an amount equal to 180 kg/m³ of photocatalyst particles and with a total amount substantially equal to 1079 kg/m³ of components for forming the second binder and water.

As for Example 2, prior to mixing, the dioritic sand has preferentially undergone screening on a 1 mm screen.

The synthetic aggregate B is obtained by mixing one tonne of 2/8 gravel in a mixer, which gravel is coated with 1600 kg of the coating composition of Example 4, and then by covering the coated grains obtained with an antibonding agent as defined above, by performing the final curing of the coating composition, and finally by performing screening to select grains preferentially between 6.3 and 10 mm in size.

Such a synthetic aggregate with photocatalytic properties has extremely advantageous properties that enable it to be used in depolluting wearing courses that show excellent adherence to tires.

According to this embodiment, the necessary amounts of photocatalyst are smaller than for the first embodiment.

1. A synthetic aggregate with photocatalytic properties for road use, formed from an assembly of grains, each comprising, included in a matrix formed by a hydraulic or pozzolanic binder, at least photocatalyst particles and a particulate mineral material that is a sand, the synthetic aggregate having a particle size d/D with D between 4 and 10.

2. The synthetic aggregate according to claim 1, characterized in that said photocatalyst particles are particles of titanium dioxide, preferably of anatase titanium dioxide.

3. The synthetic aggregate according to claim 1, characterized in that the matrix formed by a first binder, which comprises the particulate mineral material and the photocatalyst particles, constitutes the core of the grains of the synthetic aggregate.

4. The synthetic aggregate according to claim 3, characterized in that it comprises between 0.5% and 50% by weight and preferably between 5% and 15% by weight of photocatalyst particles relative to the total weight of said grains.

5. The synthetic aggregate according to claim 1, characterized in that the matrix formed by a second binder, which comprises the particulate mineral material and the photocatalyst particles, is at the surface of the grains of the synthetic aggregate, where it constitutes a coating layer, the core of the grains of the synthetic aggregate then being formed by the grains of a starting aggregate.

6. The synthetic aggregate according to claim 1, characterized in that said first binder and said second binder are both identical or different hydraulic or pozzolanic binders.

7. A process for producing a synthetic aggregate with photocatalytic properties for road use according to claim 1, characterized in that it comprises the following steps:
(a) preparation of a mortar comprising a particulate mineral material, a first binder and photocatalyst particles;
(b) curing of said mortar;
(c) crushing of said mortar into grains; and
(d) curing of said mortar grains, to obtain said synthetic aggregate.

8. The process according to claim 7, characterized in that step b) of curing said mortar corresponds to a succession of two curing operations.

9. A process for producing a synthetic aggregate with photocatalytic properties for road use according to claim 1, characterized in that it comprises the following steps:
(a) coating of a starting aggregate with a coating composition comprising a particulate mineral material, a second binder and photocatalyst particles;
(b) covering of the grains obtained with an antibonding agent or mobilizing of the grains for the first days; and
(c) curing of said coating composition.

10. A depolluting wearing course obtained by mixing the synthetic aggregate according to claim 1 with a bituminous binder, characterized in that the synthetic aggregate has a particle size d/D with D between 4 and 10.

11. The synthetic aggregate according to claim 2, characterized in that the matrix formed by a first binder, which comprises the particulate mineral material and the photocatalyst particles, constitutes the core of the grains of the synthetic aggregate.

12. The synthetic aggregate according to claim 2, characterized in that the matrix formed by a second binder, which comprises the particulate mineral material and the photocatalyst particles, is at the surface of the grains of the synthetic aggregate, where it constitutes a coating layer, the core of the grains of the synthetic aggregate then being formed by the grains of a starting aggregate.
